(19) United States
(12) Patent Application Publication
(10) Pub. No.: US 2022/0023686 A1
(43) Pub. Date: Jan. 27, 2022

(54) FRAME ASSEMBLY FOR COLLAPSIBLE AERIAL FIRE FIGHTING BUCKETS AND COLLAPSIBLE AERIAL FIRE FIGHTING BUCKETS HAVING SAME

(71) Applicant: DONMARK HOLDINGS INC., Delta (CA)

(72) Inventors: Donald Brian ARNEY, Delta (CA); Eddie Chi-Kong KWONG, Victoria (CA); Mark Dwayne TOECKES, Delta (CA)

(21) Appl. No.: 16/938,716

(22) Filed: Jul. 24, 2020

(51) Int. Cl. A62C 3/02; A62C 31/28

(52) U.S. Cl. CPC A62C 3/0235; A62C 31/28

(57) ABSTRACT

A frame assembly for a collapsible firefighting bucket for helicopters and being operable to open a rim of the bucket for filling with water and to collapse the rim for storage of the bucket, the frame assembly comprising a hub, a plurality of spokes radiating from the hub and being connected to the rim, each spoke having an inner end near the hub that is pivotably connected to the hub and an outer end near the rim that is pivotably connected to the rim, and a stop positioned below each pivotable connection of the inner end and the hub to limit the downward pivoting of the spoke relative to the hub. A collapsible firefighting bucket for helicopters having such frame assembly.

### BACKGROUND OF THE INVENTION

### Field of the Invention

The invention relates to a collapsible fire fighting bucket for being suspended from a helicopter for fighting forest fires, and in particular to a collapsible fire fighting bucket having a hub and spoke assembly that opens the mouth of the bucket as the weight of the bucket increases and load is taken up by the suspension cables.

### Description of Related Art

Collapsible firefighting buckets carried by helicopters have become standard equipment for fighting wildfires, and examples of such fire buckets are found in U.S. Pat. Nos. 4,474,245 and 4,576,287 to Donald B. Arney, and U.S. Pat. No. 5,560,429 to Robert D. Needham, all of which are incorporated herein by reference. With reference to FIGS. 1-3, these patents generally disclose fire fighting buckets 1 made of pliable waterproof fabric material having an open upper end with a rim 2 that defines a mouth of the bucket that facilitates filling of the bucket from an open body of water, a side wall 3 extending downwardly from the rim, and a bottom 4 cooperating with the side wall and having an opening. The buckets typically include a harness (not illustrated) for suspending the bucket from a helicopter, the harness typically comprising a control head, which also serves as a connector for connecting to the helicopter, and a plurality of support cables connected to the control head. The harness also includes a plurality of support cables or flexible fabric straps disposed in a zig-zag fashion around and extending upwardly from the upper rim 2 to connect with the plurality of cables. The harness thereby provides an example of a suspension mechanism that enables the bucket to be suspended from the helicopter. Other examples of suspension mechanisms may be found in the prior art.

A valve mechanism 5 is provided at an opening in the bottom of the bucket to function as a dump valve. Various valve mechanisms are known in the art of which only one kind is illustrated herein in which the valve 5 is a motor actuated rigid valve.

A frame assembly 9 is typically provided in cooperation with the rim 2 to provide structure to the mouth portion of the bucket. The frame assembly 9 of the prior art comprises a ring-like hub 12, located centrally with respect to the rim 2, from which a plurality of radial spokes 14 radiate to attachment brackets 16 adjacent the rim 2. Each spoke 14 at its inner end near the hub 12 is attached to a bracket 18 by a pin 20 that passes through the bracket 18 and the end of the spoke such that the spoke pivots around the pin 20 relative to the hub 12. On the outer end of the spoke 14 near the rim 2, each spoke 14 is attached to the bracket 16 by a pin 24 that passes through the bracket 16 and the end of the spoke such that the spoke pivots around the pin 24 relative to the bracket 16.

For storage, the hub 12 can be pushed down into the central cavity of the bucket 1, pulling the inner ends of the spokes 14 with them. This allows the mouth of the bucket to collapse and maintain the advantage of a collapsible bucket.

Attached to the central hub 12 is a deployment cable 26, the upper end of which is attached to the suspension point where the bucket connects to the helicopter. The deployment cable 26 is a length such that it is shorter than the main suspension lines running from the suspension point to the perimeter of the bucket mouth. Thus, when the bucket is first lifted by the suspension point, the weight is taken up by the deployment cable. This causes the hub 12 to be pulled up from the central cavity of the bucket, and in doing so, forces the spokes 14 radially against the perimeter rim 2 of the bucket causing it to open. Hence the frame assembly 9 operates as an instant deployment system for the bucket.

With the bucket 1 in the open position, the deployment cable 26 has slack and the weight of the bucket is taken up by the plurality of suspension lines around the perimeter of the bucket leading to the suspension point. If the hub 12 was allowed to continue unrestrained in the upwards direction, it would allow the mouth of the bucket to close. Thus, a system is provided to restrain the maximum upwards movement of the hub 12. This consists of (usually) two restrainer cables 28 which are attached at their upper ends to the hub 12, and at their lower ends to brackets 30 in the lower part of the bucket 1. When the bucket is deployed and empty of water, the restrainer cables 28 are under tension at their maximum extension. As the bucket fills with water, radial pressure from the water pushes outwards on the mouth of the bucket, forcing the hub to lower slightly, and takes the load off the restrainer cables 28. However, when the bucket is in its collapsed position with the hub 12 inside of the bucket, the restrainer cables 28 are slack and coil up inside of the bucket. In a typical bucket geometry, the amount of excess cable to be dealt with can be as much as 80% of the overall restrainer cable length. For newer generation valves 5 with rigid components in the bucket, the slack restrainer cables 28 can be a problem. When the bucket is collapsed, the slack restrainer cables 28 can wrap around exposed valve components that, when the bucket is deployed, become entangled in the valve components causing potential damage and preventing proper deployment of the frame assembly 9, hence the bucket. This results in an aborted water fill attempt by the helicopter and necessitates landing the bucket in the proximity of ground personnel who must manually untangle the cables, resulting in lost forest fire fighting time.

### SUMMARY OF THE INVENTION

In order to address some of the shortcomings in the prior art, the present invention replaces the restrainer cables of the prior art with a different mechanism to restrain the upward movement of the hub. In this invention, the rotational motion between the inner end of the spokes and the hub is now controlled. A restriction member or stop is placed on the connection such that the spokes can only pivot a fixed angle downwards when the hub is in the open position. This effectively limits the upward movement of the hub and maintains the mouth of the bucket in the open position. The spokes are still allowed to pivot fully upwards so that the hub can collapse into the bucket for storage. The stop may be accomplished by a number of structures. For example, in a first embodiment the structure of the hub is provided with an extended step or platform below the pivot point of the inner end of the spoke that limits the pivoting range of the inner end in the downwards direction. In a second embodiment, the stop is achieved by providing a restricting bracket at each hub and spoke connection. The bracket is in the form of a “U” bracket that attaches to the pivotable connection using the same pin and bolt connection that secures the spoke to the hub. The dimensions of the bracket are such that the base of the bracket interferes with the adjacent inner end of the spoke to limit the downward pivoting range of the spoke.

Accordingly, in some aspects, the present invention provides a frame assembly for a collapsible firefighting bucket and being operable to open a rim of the bucket for filling with water and to collapse the rim for storage of the bucket, the frame assembly comprising: a hub; a plurality of spokes radiating from the hub and being connected to the rim, each spoke having an inner end near the hub that is pivotably connected to the hub and an outer end near the rim that is pivotably connected to the rim; and a stop positioned below each pivotable connection of the inner end and the hub to limit the downward pivoting of the spoke relative to the hub. In some embodiments, the hub is located centrally of the rim of the bucket.

In some embodiments, the stop comprises a plurality of brackets mounted on the pivotable connection between the inner ends of the spokes and the hub, each bracket having a base positioned below the corresponding pivotable connection to interfere with downward rotation of the corresponding inner end.

In some embodiments, the stop comprises a plurality of platform members on the hub at each pivotable connection between the inner ends of the spokes and the hub, each platform member positioned below the corresponding pivotable connection to interfere with downward rotation of the inner end. The plurality of platform members may be integral with the hub.

In other aspects, the present invention provides a collapsible firefighting bucket for being suspended from a helicopter, the firefighting bucket comprising: an open bucket body of pliable material having an upper rim to facilitate filling from a body of water, a side wall extending downwardly from the rim and a bottom cooperating with the side wall, and a discharge valve on the bottom for discharging liquid from the bucket; a frame assembly cooperating with the rim and being operable to open the rim for filling with water and to collapse the rim for storage of the bucket, the frame assembly comprising a hub located centrally of the rim, a plurality of spokes radiating from the hub and being connected to the rim, each spoke having an inner end near the hub that is pivotably connected to the hub and an outer end near the rim that is pivotably connected to the rim, and a stop positioned below each pivotable connection of the inner end and the hub to limit the downward pivoting of the spoke relative to the hub; and a deployment cable connected to the frame assembly operable to pull the hub upward upon the bucket being loaded to open the rim until the spokes reach the limit provided by the stop.

In some embodiments, the stop comprises a plurality of brackets mounted on the pivotable connection between the inner ends of the spokes and the hub, each bracket having a base positioned below the corresponding pivotable connection to interfere with downward rotation of the corresponding inner end.

In some embodiments, the stop comprises a plurality of platform members on the hub at each pivotable connection between the inner ends of the spokes and the hub, each platform member positioned below the corresponding pivotable connection to interfere with downward rotation of the inner end. The plurality of platform members may be integral with the hub.

### BRIEF DESCRIPTION OF THE DRAWINGS

Further features and advantages will be apparent from the following detailed description, given by way of example, of preferred embodiments taken in conjunction with the accompanying drawings, wherein:

FIG. 1 is a perspective view of a collapsible firefighting bucket for being suspended from a helicopter in accordance with the prior art;

FIG. 2 is a section view of the prior art collapsible firefighting bucket shown in FIG. 1;

FIG. 3 is an exploded close up view of a portion of the frame member of the collapsible firefighting bucket shown in FIG. t

FIG. 4 is a section view of a collapsible firefighting bucket in accordance with an embodiment of the present invention;

FIG. 5 is a close up view of a portion of an embodiment of the frame member of the collapsible firefighting bucket shown in FIG. 4;

FIG. 6 is a top view of the portion of the frame member shown in FIG. 5;

FIG. 7 is section of the frame member along line A-A shown in FIG. 6;

FIG. 8 is a close up view of a portion of another embodiment of the frame member of the collapsible firefighting bucket shown in FIG. 4;

FIG. 9 is a top view of the portion of the frame member shown in FIG. 8; and

FIG. 10 is section of the frame member along line B-B shown in FIG. 9;

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention as defined by the claims.

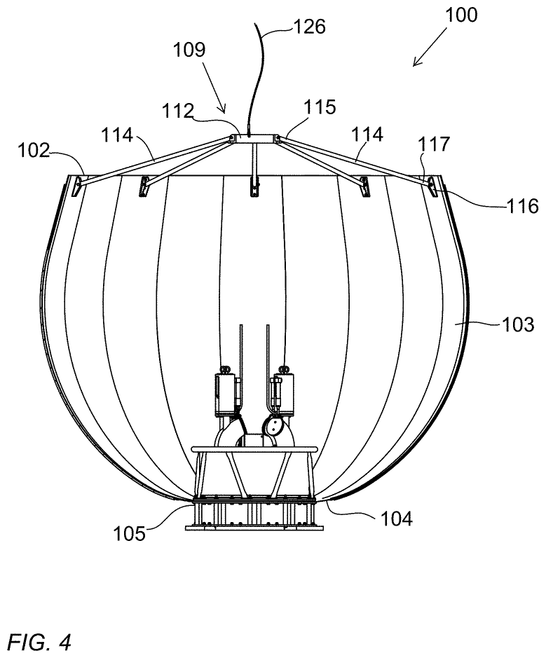

Referring to FIGS. 4-10, a fire fighting bucket 100 according to the invention bears many similarities to the earlier fire fighting buckets as disclosed in the aforementioned U.S. Pat. Nos. 4,474,245, 4,576,237, and 5,560,429. The bucket 100 has an open bucket body made of a tough pliable waterproof material and has an open upper end with a rim 102 that defines a mouth of the bucket that facilitates filling of the bucket from an open body of water by dipping into the water, a side wall 103 extending downwardly from the rim, and a bottom 104 cooperating with the side wall and having an opening. The bucket 100 may be provided with a harness (not illustrated) for suspending the bucket from a helicopter, the harness may include a control head that also serves as a connector for connecting to the helicopter, and a plurality of support cables connected to the control head.

A valve mechanism 105 is provided at an opening in the bottom of the bucket to function as a dump valve. Various valve mechanisms are known in the art of which only one kind is illustrated herein in which the valve 5 is a motor actuated rigid valve.

A frame assembly 109 is provided in cooperation with the rim 102 to provide structure to the mouth portion of the bucket 100. The frame assembly 109 of the present invention comprises a ring-like hub 112, preferably located centrally with respect to the rim 102, from which a plurality of radial spokes 114 radiate to attachment brackets 116 adjacent the rim 102. Each spoke 114 at its inner end 115 near the hub 112 is attached to a bracket 118 by a pivotable connection such as nut 120 that passes through the bracket 118 and the inner end 115 of the spoke 114 such that the spoke pivots around the pin 120 relative to the hub 12. A stop 150 is positioned below each pivotable connection of the inner end 115 and the hub 112 to limit the downward pivoting of the spoke 114 relative to the hub.

On the outer end 117 of the spoke 114 near the rim 102, each spoke 114 is attached to the bracket 116 by a pivotable connection such as a nut (not shown) that passes through the bracket 116 and the outer end 117 of the spoke 114 such that the spoke pivots around the pin 124 relative to the bracket 116.

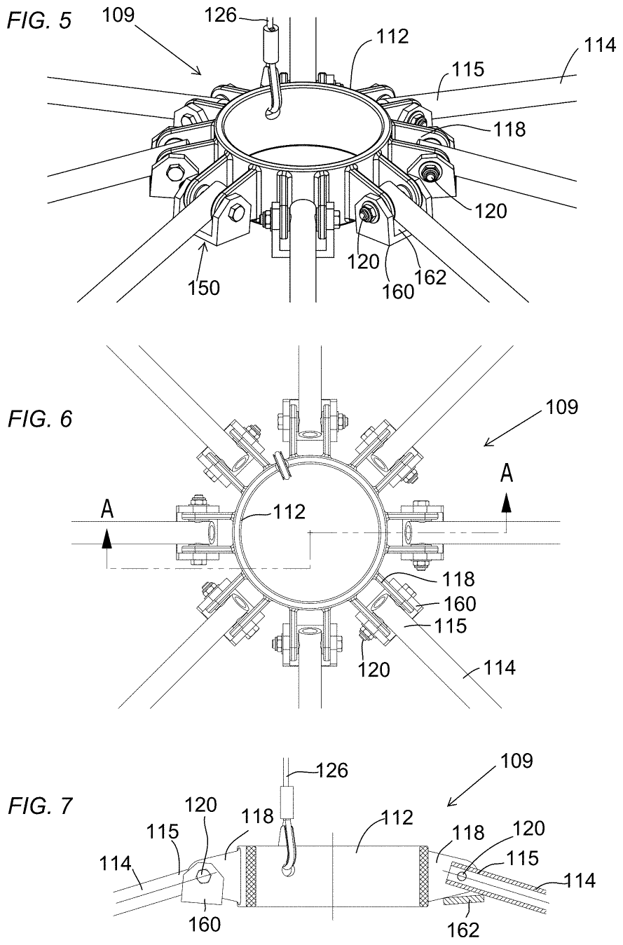

Referring to FIGS. 5-7, one embodiment of the stop 150 is shown as a plurality of brackets 160 mounted on the pivotable connection between the inner ends 115 of the spokes 114 and the hub 112, each bracket being generally U-shaped and having a base 162 positioned below the corresponding pivotable connection to interfere with downward rotation of the corresponding inner end 115.

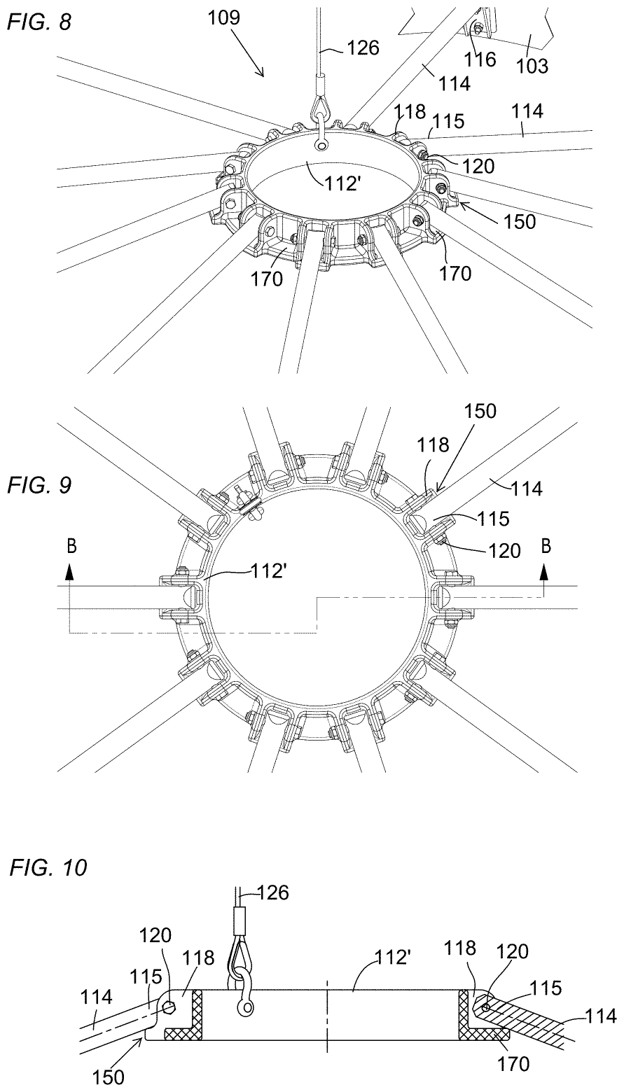

Referring to FIGS. 8-10, another embodiment of the stop 150 is shown as a plurality of platform members 170 on a modified hub 112′ at each pivotable connection between the inner ends 115 of the spokes 114 and the hub 112′, each platform member 170 is positioned below the corresponding pivotable connection to interfere with downward rotation of the inner end 115. The platform members 170 may be integral with the hub 112′ such as being cast or formed with the hub as a unitary body at the time of manufacture of the hub, as illustrated.

For storage, the hub 112 can be pushed down into the central cavity of the bucket 100, pulling the inner ends 115 of the spokes 114 with it. This allows the mouth of the bucket 100 to collapse and maintain the advantage of a collapsible bucket.

Attached to the central hub 112 is a deployment cable 126, the upper end of which is attached to the suspension point where the bucket connects to the helicopter. The deployment cable 126 is a length such that it is shorter than the main suspension lines running from the suspension point to the perimeter of the bucket mouth. Thus, when the bucket 100 is first lifted by the suspension point, the weight is taken up by the deployment cable 126. This causes the hub 112 to be pulled up from the central cavity of the bucket 100, and in doing so, forces the spokes 114 radially against the perimeter rim 102 of the bucket causing it to open. Hence the frame assembly 109 operates to open the rim 102 of the bucket 100 for filling with water and to collapse the rim 102 for storage of the bucket 100.

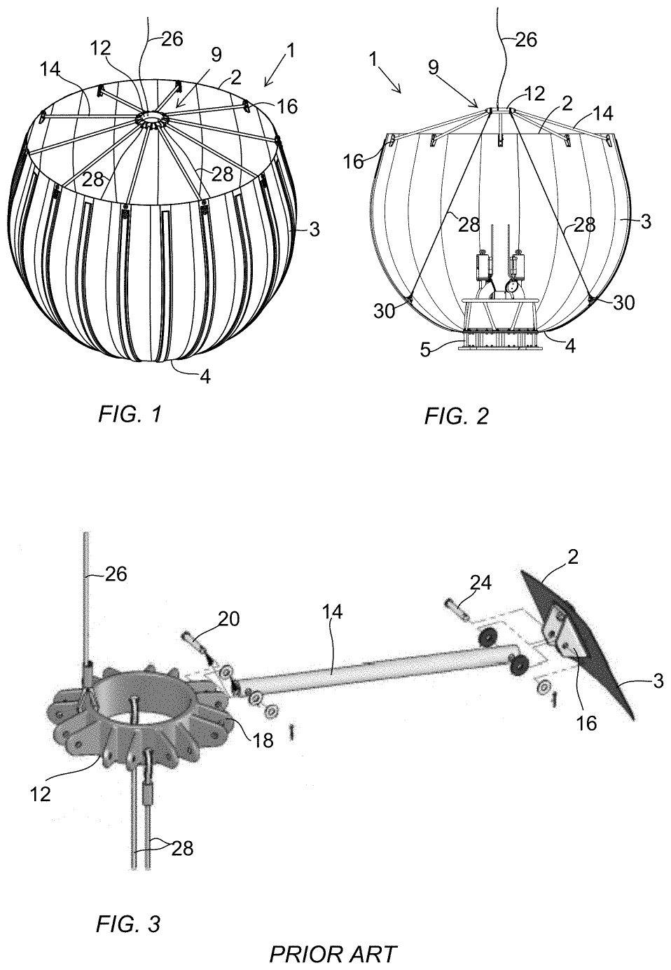

With the bucket 100 in the open position, the deployment cable 126 has slack and the weight of the bucket is taken up by the plurality of suspension lines around the perimeter of the bucket leading to the suspension point. If the hub 112 was allowed to continue unrestrained in the upwards direction, it would allow the mouth of the bucket to close. Thus, the stop 150 is provided to restrain the maximum upwards movement of the hub 12 by limiting the downward pivoting range of each spoke 114 at its inner end 115 at the pivotable connection with the hub 112. This makes it unnecessary to provide restrainer cables such as restrainer cables 28 (FIG. 1) of the prior art, which overcomes the tangling problem encountered in the prior art as a result of slack in the restrainer cables.

While specific embodiments of the invention have been described, such embodiments are illustrative of the invention only and should not be taken as limiting its scope. In light of the present disclosure, many modifications will occur to those skilled in the art to which the invention relates, and the invention, therefore, should be construed in accordance with the accompanying claims.

What is claimed is:

1. A frame assembly for a collapsible firefighting bucket and being operable to open a rim of the bucket for filling with water and to collapse the rim for storage of the bucket, the frame assembly comprising:
a hub;
a plurality of spokes radiating from the hub and being connected to the rim, each spoke having an inner end near the hub that is pivotably connected to the hub and an outer end near the rim that is pivotably connected to the rim; and
a stop positioned below each pivotable connection of the inner end and the hub to limit the downward pivoting of the spoke relative to the hub.

2. The device as claimed in claim 1, wherein the hub is located centrally of the rim of the bucket.

3. The device as claimed in claim 1, wherein the stop comprises a plurality of brackets mounted on the pivotable connection between the inner ends of the spokes and the hub, each bracket having a base positioned below the corresponding pivotable connection to interfere with downward rotation of the corresponding inner end.

4. The device as claimed in claim 1, wherein the stop comprises a plurality of platform members on the hub at each pivotable connection between the inner ends of the spokes and the hub, each platform member positioned below the corresponding pivotable connection to interfere with downward rotation of the inner end.

5. The device as claimed in claim 4, wherein the plurality of platform members is integral with the hub.

6. The device as claimed in claim 2, wherein the stop comprises a plurality of brackets mounted on the pivotable connection between the inner ends of the spokes and the hub, each bracket having a base positioned below the corresponding pivotable connection to interfere with downward rotation of the corresponding inner end.

7. The device as claimed in claim 2, wherein the stop comprises a plurality of platform members on the hub at each pivotable connection between the inner ends of the spokes and the hub, each platform member positioned below the corresponding pivotable connection to interfere with downward rotation of the inner end.

8. The device as claimed in claim 7, wherein the plurality of platform members is integral with the hub.

9. A collapsible firefighting bucket for being suspended from a helicopter, the firefighting bucket comprising:
an open bucket body of pliable material having an upper rim to facilitate filling from a body of water, a side wall extending downwardly from the rim and a bottom cooperating with the side wall, and a discharge valve on the bottom for discharging liquid from the bucket;
a frame assembly cooperating with the rim and being operable to open the rim for filling with water and to collapse the rim for storage of the bucket, the frame assembly comprising a hub located centrally of the rim, a plurality of spokes radiating from the hub and being connected to the rim, each spoke having an inner end near the hub that is pivotably connected to the hub and an outer end near the rim that is pivotably connected to the rim, and a stop positioned below each pivotable connection of the inner end and the hub to limit the downward pivoting of the spoke relative to the hub; and
a deployment cable connected to the frame assembly operable to pull the hub upward upon the bucket being loaded to open the rim until the spokes reach the limit provided by the stop.
The device as claimed in claim 9, wherein the stop comprises a plurality of brackets mounted on the pivotable connection between the inner ends of the spokes and the hub, each bracket having a base positioned below the corresponding pivotable connection to interfere with downward rotation of the corresponding inner end.

10. The device as claimed in claim 9, wherein the stop comprises a plurality of platform members on the hub at each pivotable connection between the inner ends of the spokes and the hub, each platform member positioned below the corresponding pivotable connection to interfere with downward rotation of the inner end.

11. The device as claimed in claim 10, wherein the plurality of platform members is integral with the hub.
